(19) United States
(12) Patent Application Publication
(10) Pub. No.: US 2015/0282659 A1
(43) Pub. Date: Oct. 8, 2015

(54) INSTANT COOKING SYSTEM

(71) Applicant: Yong Seung Ham, Gyeonggi-do (KR)

(72) Inventor: Yong Seung Ham, Gyeonggi-do (KR)

(21) Appl. No.: 14/441,262

(22) PCT Filed: Sep. 26, 2013
(86) PCT No.: PCT/KR2013/008638

§ 371 Date: May 7, 2015

(30) Foreign Application Priority Data
Dec. 10, 2012 (KR) 20-2012-0011564

(51) Int. Cl. A47J 27/10; A47J 27/00

(52) U.S. Cl. CPC A47J 27/10; A47J 27/002

(57) ABSTRACT

The present invention relates to an instant cooking system for enabling the user to readily cook food by heating a cooking liquid such as water or meat juice with washed grain or a semi-prepared cooking stuff. To this end, the system of the present invention is characterized by including: a material supply unit arranged to communicate with the bottom of a storage part containing a powdered or particulate cooking stuff for conveying and supplying the cooking stuff according to an applied control signal; a cooking liquid supply unit connected to a vessel containing a cooking liquid for supplying the cooking liquid according to an applied control signal; a main body connected to the storage part and the vessel for mounting therein the material supply unit and the cooking liquid supply unit, a cooking region being provided below the material supply unit and the cooking liquid supply unit; a cooking unit shaped like a pot with a cover for cooking food by heating the cooking liquid supplied from the cooking liquid supply unit with the is cooking stuff supplied from the material supply unit according to an applied control signal, the cooking unit selectively being mounted in or withdrawn from the cooking region, the cooking unit being electrically connected to receive the cooking stuff and the cooking liquid only by inserting an internal case into the pot; and a control unit installed inside the main body for controlling the operation of the material supply unit, the cooking liquid supply unit, and the cooking unit.

### TECHNICAL FIELD

The present invention relates to an instant cooking system, and in particular to an instant cooking system which may allow an instant cooking in order for a user to instantly cook when cooking an edible food in such a way to heat together cooking water, for example, water or meat broth and washed grains or various semi-processed instant ingredients.

### BACKGROUND ART

In general, rice, which is a main meal in many countries, can be cooked in such a way to wash clean one or more than one kind of grain, for example, rice, barley, etc. and put the washed grain in a cooking pot together with water and heat for a predetermine time.

Soup, porridge and a predetermined food made of a self-processed ingredient, except for the above-mentioned rice, need a mixing procedure for mixing a cooking ingredient and cooking water by a predetermined amount and at a predetermined ratio, and a heating procedure for a predetermined time corresponding to the condition of a corresponding ingredient.

When cooking each of the above-mentioned foods, a user should do many complicated procedures from a procedure of preparing cooking ingredients, for example, water level adjustment and cooking time set in accordance with each food to the cooking of the food. In addition, the user should learn various cooking conditions.

Among the above-mentioned cooking instruments, there are various electric rice cookers one of which is disclosed in the Korean patent application number 10-2006-0038646. Even for the above-mentioned electric rice cooker, a user should have a knowledge for adjusting the level of water.

### DISCLOSURE OF INVENTION

### Technical Problem

Accordingly, the present invention is made in an effort to resolve the above-mentioned problems. It is an object of the present invention to provide an is instant cooking system which allows any user to easily cook in such a way to supply grains, for example, cleanly washed rice or barley, powder made by semi-processed meat, vegetable, etc. and including such grains or a predetermined amount of cooking water corresponding to a granular type ingredient.

It is another object of the present invention to provide an instant cooking system which makes it possible to minimize standby power when using electric energy which is necessary for cooking.

### Solution to problem

To achieve the above objects, there is provided an instant cooking system, which may include an ingredient supply unit which is communicatively disposed below a storing unit configured to accommodate powder type or granular type cooking ingredients, thus transferring and supplying the cooking ingredients in accordance with a received control signal; a water supply unit which is connected to a water tank configured to store cooking water and supplies the cooking water in accordance with a control signal; a main body which provides a cooking area below the ingredient supply unit and the water supply unit and is connected to the storing unit and the water tank, wherein the ingredient supply unit and the water supply unit are installed inside the main body; a cooking unit which is configured in a container shape with a cover and is engaged or disengaged since the cooking is unit is selectively inputted in the cooking area and is electrically connected based on the engagement thereof and accommodates the cooking ingredient and the cooking water supplied by the ingredient supply unit and the water supply unit, thus heating and cooking in accordance with a received control signal; and a control unit which is installed inside the main body and serves to control the operations of the ingredient supply unit, the water supply unit and the cooking unit.

### Advantageous Effects

According to the instant cooking system of the present invention,

first, men and women of all ages can easily cook a predetermined food corresponding to a cooking ingredient in a semi-processed state, for example, rice, soup, porridge, etc.

Second, since a cooking ingredient and cooking water determined based on a food supply amount may be automatically supplied, a skilled cooking ingredient supply adjustment or a skilled cooking water adjustment is not necessary.

Third, since electric power may be supplied to each component, for example, a main body, a heating unit, etc. once a cooking unit is completely installed on the top of the main body, thus minimizing unnecessary standby power.

Fourth, since nuclear family consisting of about 1 to 4 members increases, and economical activity population increases, a faster and easier cooking preparation is possible, thus saving time and cost.

Fifth, it does not need to store lots of grains including rice, and a semi-processed cooking ingredients, and the present invention requires a small installation space, thus effectively utilizing dead space.

### BRIEF DESCRIPTION OF DRAWINGS

FIG. 1 is a schematic perspective view illustrating a configuration of an instant cooking system and an assembled state of the configuration according to an exemplary embodiment of the present invention.

FIG. 2 is a schematic side surface cross sectional view for describing a configuration of each component of the instant cooking system in FIG. 1 and an engaged relationship and an operation relationship of the configuration.

FIG. 3 is a partially enlarged view illustrating a configuration of a cooking unit corresponding to the arrow portion III in FIG. 1 and a cooking area where the installation is made.

FIG. 4 is a disassembled perspective view illustrating an engaged relationship of each component of a cooking unit in FIG. 1.

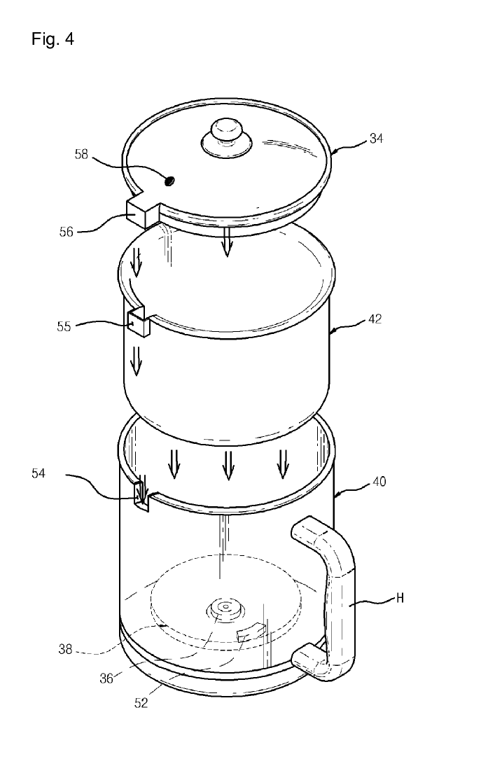

FIG. 5 is a schematic diagram illustrating a driving relationship of an instant cooking system according to an exemplary embodiment of the present invention.

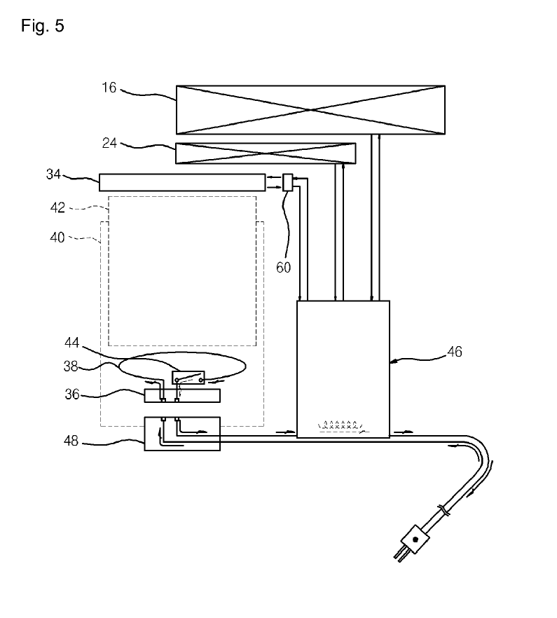

FIG. 6 is a flow chart for describing an operation procedure of an instant cooking system according to an exemplary embodiment of the present invention.

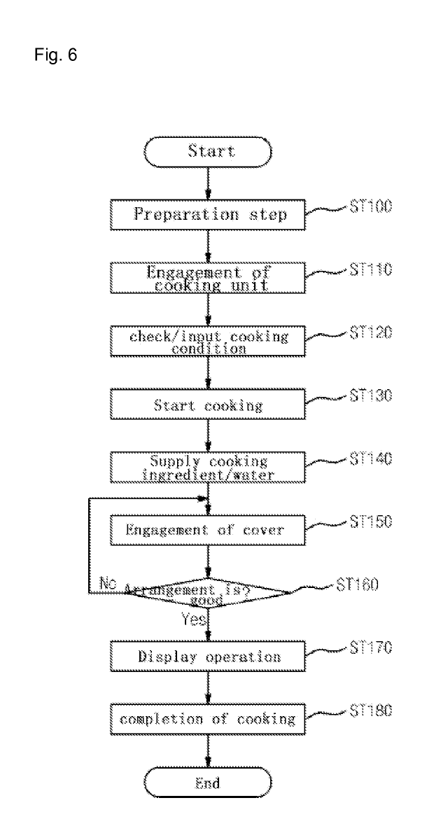

### BEST MODES FOR CARRYING OUT THE INVENTION

The instant cooking system according to an exemplary embodiment of the present invention will be descried with reference to the accompanying drawings.

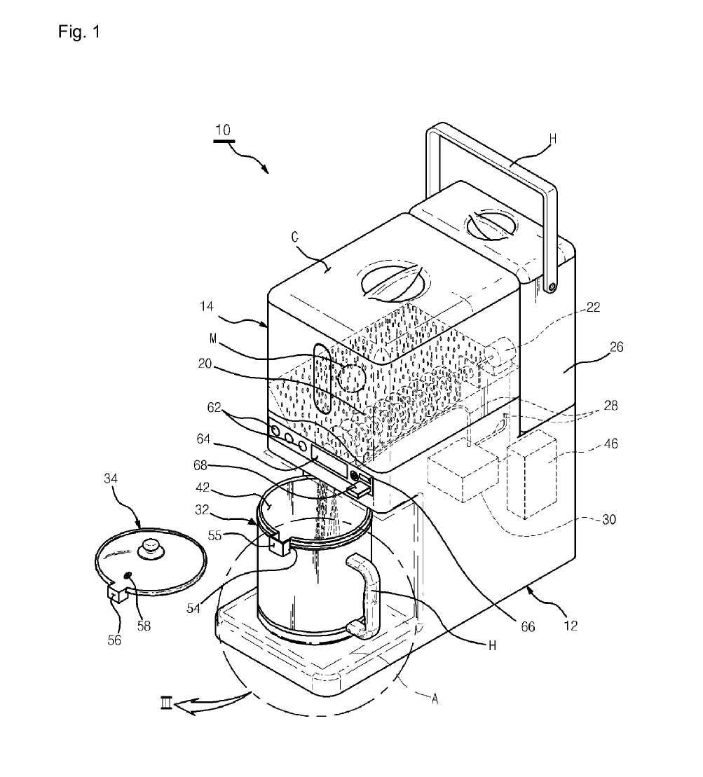

As illustrated in FIG. 1, the instant cooking system 10 according to the present invention may include a storing unit 14 disposed at the top of a main body 12 for accommodating a powder type or granular type cooking ingredient ‘M’ from the direction of the opening of a cover ‘C’ of the top, and the storing unit 14 is configured to move the accommodated cooking ingredient ‘M’ in a downward direction with the aid of self-weight, wherein the inner lower side of the storing unit 14 is formed in a hopper shape.

In addition, an ingredient supply unit 16 is communicatively arranged inside of the main body 12 at the bottom of the storing unit 14, and the ingredient is supply unit 16 serves to transfer and supply to a set position the cooking ingredient ‘M’ which is inputted through the bottom of the storing unit 14 in accordance with a received control signal from a control unit 46, which will be described later.

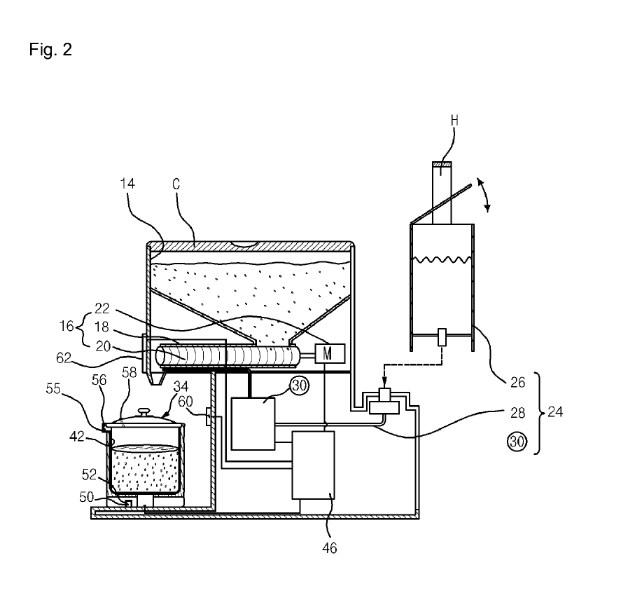

The configuration of the above-mentioned ingredient supply unit 16 will be more specifically described. As illustrated in FIG. 1 or FIG. 2, there are provided a supply tube body 18 which is formed in a tubular shape and allows the cooking ingredient ‘M’ to be inputted since a partial section of a side part is communicative to the bottom of the storing unit 14, wherein one end of the supply tube body 18 is arranged at the front side of the main body 12, thus forming a discharge port of the cooking ingredient ‘M’, a screw 20 which is rotatably installed inside of the supply tube body 18, and a driving motor 22 which provides a driving force so as to rotate the screw 20 connected through the other end of the supply tube body 18 in accordance with an inputted control signal.

In addition, as illustrated in FIG. 1 or FIG. 2, the main body 12 may include a water supply unit 24 for supplying, together with a cooking ingredient of the ingredient supply unit 16, the cooking water, for example, water, meat broth, etc., in accordance with a received control signal.

The water supply unit 24 may include a water tank 26 configured to accommodate cooking water and disposed at one side of the main body 12, a hose 28 one end of which is placed near one end of the ingredient supply unit 16, and the end of which is communicatively connected for the sake of the low of the cooking water thanks to the engagement of the water tank 26, and a pump 30 which is communicatively installed at the hose 28 and serves to supply a flow pressure of the water through the hose 28 in accordance with a control signal.

In addition, at the front bottom of the main body 12, more specifically, at the bottom vertically corresponding to one end of each of the ingredient supply unit 16 and the water supply unit 24, there is provided a cooking area ‘A’ having a predetermined space which is concave in a E-shape when viewing from its side surface, and in the cooking area ‘A’, there is installed a cooking unit 32 which is configured to accommodate the cooking ingredients transferred and falling by the driving of the ingredient supply unit 16 and the water supply unit 24.

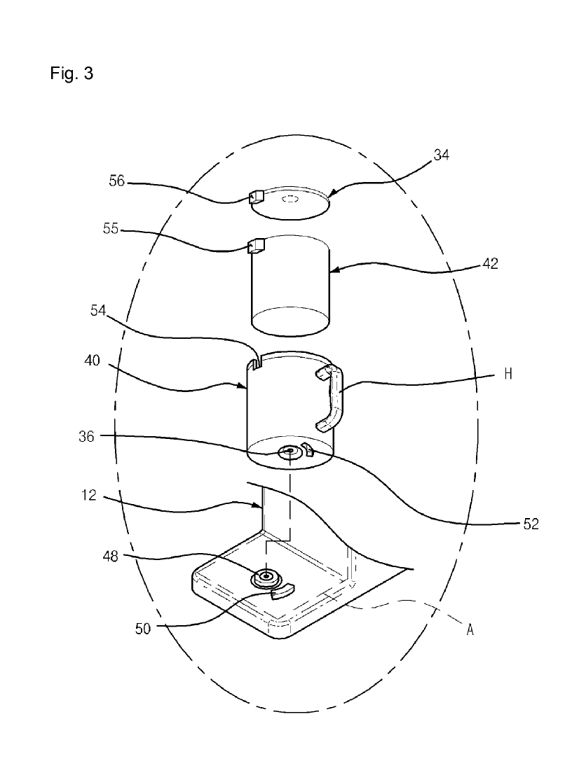

As illustrated in FIGS. 1 to 3, the above-mentioned cooking unit 32 is formed in a container shape with the cover 34 and is engaged or disengaged since the cooking unit 32 is selectively loaded into or unloaded from the cooking area ‘A’. When the cooking unit 32 is engaged in the cooking area ‘A’, the cooking unit 32 is electrically connected with the main body 12. In a state where the cover 34 is openned, the cooking unit 32 accommodates cooking ingredient and water which are transferred and falling from the ingredient supply unit 16 and the water supply is unit 24 which are disposed above them. In a state where the cover 34 is closed, the cooking unit 32 serves to heat and cook in accordance with a received control signal.

Here, the connection relationship between the cooking unit 32 and the cooking area ‘A’ where the cooking unit 32 is installed, will be described in details.

First, as illustrated in FIG. 1 or FIG. 2, in the cooking area ‘A’, a first terminal unit 48 is provided at a bottom surface of the main body 12 where the bottom side of the cooking unit 32 is placed.

In addition, the cooking unit 32 may include an outer case 40 which has a second terminal unit 36 formed at its bottom surface and electrically connected to the first terminal unit 48, and a heating unit 38 which is disposed at its inner side and is connected to the second terminal unit 36 and serves to convert electric energy into heat energy, an inner case 42 which is inserted to the outer case 40 and is engaged in the cooking area ‘A’ with the cover 34 open and serves to receive and accommodate the cooking ingredient and cooking water from the ingredient supply unit 16 and the water supply unit 24, and a switch 44 for switching on/off electric power to the second terminal unit 36, the heating unit 38 and the controller 46 with respect to each component of the main body 12 in accordance with the insertion of the inner case 42 with respect to the outer case 40.

At this time, the switch 44 serves to connect electric power between the heating unit 38 through the second terminal unit 36 when the inner case 42 is inserted in the outer case 40, and the switch 44 switches off electric power in case of the opposite occasion. The switch 44 may be various types of switches, for example, a limit switch, etc.

Here, each configuration formed of the switch 44, and the control unit 46 and the first terminal unit 48 disposed inside of the main body 12 and the second terminal unit 36 and the heating unit 38 all may be connected in series. When the switch 44 is on, each component becomes an electrically driven state, and when the switch 44 is off, each component becomes an electrically disconnected state, thus minimizing standby electric power.

Meanwhile, at the bottom surface of the main body 12 of the cooking area ‘A’, there is arranged a first arrangement unit 50 which has a protruding or concave shape corresponding to the bottom surface of the outer case 40, and at the bottom surface of the outer case 40 corresponding thereto, there is arranged a second arrangement unit 52 shaped to correspond to the first arrangement unit 50. With the aid of the arrangement between the first and second arrangement units 50 and 52, the outer case 40 can be arranged and positioned with respect to the cooking area ‘A’.

In addition, at an edge portion of the inner and outer sides of the top of the outer case 40, there is formed a third arrangement unit 54 in a shape, for example, a protrusion shape, a groove shape, etc. At an edge portion of the inner case 42 placed inside of the outer case 40, there is formed a fourth arrangement unit 55 in a groove or protrusion shape corresponding to the third arrangement unit 54. In addition, at an edge portion of the cover 34 placed thereon, there is formed a fifth arrangement unit 56 in a groove or protrusion shape corresponding to the fourth arrangement unit 55.

In addition, at one side of the top of the cover 34, a steam discharge port 58 is formed passing through in the direction where the steam producing inside of the inner case 42 discharges toward the outward direction of the main body 12 in a state where the first to fifth arrangement units 50, 52, 54, 55 and 56 are arranged.

In addition, at the third, fourth and fifth arrangement units 54, 55 and 56 or at a side portion of the main body 12 facing the arranged cover 34, there may be further provided an arrangement sensor 60 for detecting the arrangement of the cover 34 and applying a detection signal to the control unit 46.

The detection of the arrangement of the cover 34 using the arrangement sensor 60 may be performed with the aid of a typical photo-coupler is which detects the hiding by the cover 34 which more protrudes over the outer case 40 together with the inner case 42 or may be performed with the aid of a typical near position detection sensor which can detect the arrangement of the cover 34 with the aid of an electromagnetic reaction or a reflection with respect to a magnetic substance, light and sound wave on the near portion of the arranged cover 34.

The arrangement sensor 60, which will be described later in the operation descriptions, is electrically connected to the control unit 46 and is configured to be driven when electric power is supplied to the control unit 46.

More specifically, the arrangement sensor 60 is driven when electric power is supplied to the control unit 46 in a state where the switch 44 is on, thus detecting the arrangement of the cover 34 and is not driven when electric power supply to the control unit 46 is disconnected in a state where the switch 44 is off.

Meanwhile, at a side portion of the main body 12, there are provided an operation unit 62 configured for a user to select cooking, a display unit 64 configured for the user to easily check a cooking state, and an input and output port 66 wherein an external storing medium 68 is installed, which stores a data including a cooking condition with respect to cooking ingredients of the food to be cooked.

In addition, the operation unit 62, the display unit 64 and the input and output port 66 are electrically connected with respect to the control unit 46, and the control unit 46 serves to control the driving of the ingredient supply unit 16 and the water supply unit 24 based on the data stored in the storing medium 68 and control the heating temperature, heating time, etc. of the heating unit 38. The control unit 46 allows the user to check the remaining time until the completion of the whole cooking procedures, etc. on the display unit 64.

The operation procedures of the instant cooking system 10 according to the present invention will be described in the sequence of time.

First of all, the instant cooking system 10 performs a preparation step wherein grains including cleanly washed rice and a cooking ingredient ‘M’ that a user wants to cook among the cooking ingredients of semi-processed state are inputted by opening the storing unit 14 cover ‘C’, and the water tank 26 with cooking water is arranged in place (ST100).

The user inputs the cooking unit 32 wherein the cover 34 is open, and the inner case 42 is inserted inside the outer case 40 is inputted in the cooking area ‘A’ (ST110).

At this time, the first and second arrangement units 50 and 52 are arranged together, and an electric connection is made between the first and is second terminal units 48 and 36, and the switch 44 in the outer case 40 is on thanks to the mounting of the inner case 42, so each component in the main body 12 including the control unit 46 are in the standby state wherein each component can be electrically driven.

Thereafter, the user checks whether or not the set information of the cooking ingredient displayed on the display unit 64 is same as the cooking ingredient ‘M’ inputted in the storing unit 14, and if the information is not same, the user operates the operation unit 62 and performs a procedure for matching the cooking ingredient ‘M’ with the cooking condition (ST120).

When the above cooking preparation is finished, the user inputs a cooking condition corresponding to the number of persons on the operation unit 62 (ST130).

The control unit 46 which has received such an input signal controls the driving of the ingredient supply unit 16 and the water supply unit 24 in response to the information on a corresponding cooking ingredient ‘M’ based on an inner database ‘DB’, thus supplying the cooking ingredient ‘M’ and the cooking water set based on the cooking ingredient to the inner case 42 (ST140).

When the supplies of the cooking ingredient ‘M’ and the cooking water are completed, the user covers the cover 34 on the top of the cooking unit 32 (ST150).

At this time, if the arrangements of the third, fourth and fifth arrangement units 54, 55 and 56 are not made between the outer case 40 and the cover 34, the arrangement sensor 60 applies a signal corresponding to such a mismatch to the control unit, and the control unit 46, which has received the signal, displays the state information on the display unit 64 or allows the user to check such a mismatch through a separate sound unit.

Namely, the control unit 46 performs a series of procedures so as to allow the user to check the procedures from the supply of the cooking ingredient ‘M’ and the cooking water to the completion of the arrangement and placement of the cover 34.

When the arrangement of the arrangement sensor 60 is confirmed, the control unit 46 performs cooking by heating for a set time the heating unit 38, and during this procedure, the remaining time until the cooking is completed may be displayed on the display unit 64, and a series of procedures are performed in order for the user to check such a state when the cooking is completed (ST160)(ST170).

Thereafter, when the cooking is completed, the user separates the cooking unit 32 from the main body 12 and moves to a dining table or the like and eats food samples (ST180).

During the above-mentioned cooking procedures, the steam discharge port 58 formed at the cover 34 faces the outer side of the main body 12 based on the arrangement of the third, fourth and fifth arrangement units 54, 55 and 56, and the above arrangement relationship and the formation direction of the steam discharge port 58 are provided so as to protect the surface of the main body 12 from getting dirt from steam or prevent any electric damages of each component in the main body 12.

Here, the arrangement sensor 60 serves to prevent the driving of the ingredient supply unit 16 and the water supply unit 24 with the aid of the control unit 46 in a state where the cover 34 is covered on the top of the outer case 40, while allowing the checking on the clean state in the inner case 42 by opening the cover 34 and on whether or not there is any leftover of the cooked food.

In addition, the input and output port 66, which allows the engagement of the outer storing medium 68, is provided to download the data distributed online through a user computer (not shown) if the cooking ingredients ‘M’ of a new food are developed for the sake of the instant cooking system 10 according to the present invention and provide the downloaded data through the input and output port 66 to the control unit 46, thus performing a cooking thereof.

Reference symbol ‘H’ in the drawing means a handle ‘H’ that the user can grab, and the cooking unit 32 including the outer case 40 may be lifted up from the cooking area ‘A’ in the way of a wireless coffee pot by the user who has grabbed the handle ‘H’ and may be freely moved.

1. An instant cooking system, comprising:
an ingredient supply unit which is communicatively disposed below a storing unit configured to accommodate powder type or granular type cooking ingredients, thus transferring and supplying the cooking ingredients in accordance with a received control signal;
a water supply unit which is connected to a water tank configured to store cooking water and supplies the cooking water in accordance with a control signal;
a main body which provides a cooking area below the ingredient supply unit and the water supply unit and is connected to the storing unit and the water tank, wherein the ingredient supply unit and the water supply unit are installed inside the main body;
a cooking unit which is configured in a container shape with a cover and is engaged or disengaged since the cooking unit is selectively inputted in the cooking is area and is electrically connected based on the engagement thereof and accommodates the cooking ingredient and the cooking water supplied by the ingredient supply unit and the water supply unit, thus heating and cooking in accordance with a received control signal; and
a control unit which is installed inside the main body and serves to control the operations of the ingredient supply unit, the water supply unit and the cooking unit.

2. The system of claim 1, wherein the cooking area is characterized in the way that the side portion of the main body is formed in an inwardly concave shape so that the cooking unit wherein the cover is open can be placed where the cooking ingredient and the cooking water transferred by the driving of the ingredient supply unit and the water supply unit vertically fall, and at the bottom of the main body where the bottom surface of the cooking unit is placed, a first terminal is provided, and the cooking unit includes an outer case at the bottom surface of which a second terminal unit connected to the first terminal unit is provided, and at the inner side of which, there is provided a heating unit which is connected to the second terminal unit, thus converting electric energy into heat energy, an inner case which is inserted to the outer case and is engaged in the cooking area with the cover open, thus receiving and accommodating the cooking ingredient and the cooking water from the ingredient supply unit and the water supply unit, and a switch for switching on/off the electric power between the second terminal unit and the heating unit in accordance with the insertion into the inner case with respect to the outer case, and the switch is connected in series with the control unit, the first and second terminal units and the heating unit.

3. The system of claim 2, wherein at the bottom surface of the main body in the cooking area, there is formed a first arrangement unit which has a protrusion or concave shape in response to the bottom surface of the outer case, and at the bottom surface of the outer case, there is formed a second arrangement unit which has a shape corresponding to the first arrangement unit, and at a partial edge portion of the top of the outer case, there is formed a third arrangement unit, and in the inner case, there is formed a fourth arrangement unit which has a shape corresponding to the third arrangement unit, and at the cover, there is formed a fifth arrangement unit which has a shape corresponding to the fourth arrangement unit, and in a state where the first to fifth arrangement units are arranged, there is provided a steam discharge port formed from the inside of the inner case to the outward direction of the main body.

4. The system of claim 3, wherein at the third, fourth and fifth arrangement units or at a side portion of the main body facing the arranged cover, there is further provided an arrangement sensor which serves to detect the arrangement of the cover and apply the detection signal to the control unit.

5. The system of claim 1,
wherein at a side portion of the main body, there are provided an operation unit configured for a user to select cooking, a display unit configured to the user to check a cooking state, and an input and output port which has a storing medium storing a data including a cooking condition with respect to a cooking ingredient of a cooking food,
and the control unit is electrically connected to the operation unit, the display unit and the storing medium is configured to receive an operation signal based on the user selection through the operation unit and a detection signal of the arrangement sensor, thus controlling the operations of the heating unit, the ingredient supply unit, the water supply unit and the display unit.
